(19) United States
(12) Patent Application Publication
(10) Pub. No.: US 2025/0190414 A1
(43) Pub. Date: Jun. 12, 2025

(54) CODE CONVERSION APPARATUS, CODE CONVERSION METHOD, AND COMPUTER-READABLE RECORDING MEDIUM

(71) Applicant: NEC Corporation, Minato-ku, Tokyo (JP)

(72) Inventor: Yoshiyuki OHNO, Tokyo (JP)

(73) Assignee: NEC Corporation, Minato-ku, Tokyo (JP)

(21) Appl. No.: 18/875,221

(22) PCT Filed: Jul. 25, 2022
(86) PCT No.: PCT/JP2022/028643

§ 371 Date: Dec. 16, 2024

(51) Int. Cl. G06F 16/22

(52) U.S. Cl. CPC G06F 16/2264

(57) ABSTRACT

A code conversion apparatus including: a detection unit that detects first code that includes first function code; an extraction unit that extracts, from the detected first codes, second codes; a selection unit that selects key columns to be used for a link table that is obtained by reducing the number of key columns of the target two-dimensional array data, based on the aggregate computation code included in the second codes and key columns of the target two-dimensional array data; a generation unit that generates third code using the first function code, the selected key columns, and the aggregate computation code, and adding the generated third code at a beginning of the second codes; and a conversion unit that converts the plurality of second codes into fourth code by aligning the second codes with the third code, based on the third code.

### TECHNICAL FIELD

The present disclosure relates to a code conversion apparatus and a code conversion method for performing code conversion, and further relates to a computer-readable recording medium on which a program for realizing the apparatus and the method is recorded.

### BACKGROUND ART

Pre-processing for generating training data that is used for machine learning includes feature amount generation processing. In addition, it is known that feature amount generation processing takes time.

In view of this, there is demand for shortening the time required for feature amount generation processing. The reason feature amount generation processing takes time is that a plurality of columns included in two-dimensional array data are defined as key columns, and grouping computation is executed for each combination of key columns. That is to say, redundant processing is executed when there are redundant columns among the key columns.

As a related technique, Patent Document 1 discloses a technique for creating aggregation results at a high speed by reducing the number of combinations of aggregation results.

### LIST OF RELATED ART DOCUMENTS

### Patent Document

Patent Document 1: Japanese Patent Laid-Open Publication No. 11-003354

### SUMMARY OF INVENTION

### Problems to be Solved by the Invention

However, the technique of Patent Document 1 is not a technique for converting code of grouping computation that is used for feature amount generation processing or the like into code for increasing the speed (shortening the computation time).

An example object of the present disclosure is to increase the speed (shorten the computation time) of grouping computation that uses a plurality of key columns of a table (two-dimensional array data) included in input code.

### Means for Solving the Problems

In order to achieve the example object described above, a code conversion apparatus according to an example aspect of the present disclosure includes:
a detection unit that detects, from input code that was stored in a storage device in advance and has been input to be executed by a computer, first code that includes first function code for combining a plurality of key columns included in two-dimensional array data, and executing grouping computation for each combination of key columns;
an extraction unit that extracts, from a plurality of the detected first code blocks, a plurality of second code blocks between which two-dimensional array data targeted by the first function code is the same, and aggregate computation code included in the first code is the same;
a selection unit that selects key columns to be used for a link table that is obtained by reducing the number of key columns of the target two-dimensional array data, based on the aggregate computation code included in the second code blocks and key columns of the target two-dimensional array data;
a generation unit that generates third code using the first function code, the selected key columns, and the aggregates computation code, and adding the generated third code at a beginning of the second code blocks; and
a conversion unit that converts the plurality of second code blocks into fourth code by aligning the second code blocks with the third code, based on the third code.

Also, in order to achieve the example object described above, a code conversion method that is performed by a computer according to an example aspect of the present disclosure includes:
detecting, from input code that was stored in a storage device in advance and has been input to be executed by a computer, first code that includes first function code for combining a plurality of key columns included in two-dimensional array data, and executing grouping computation for each combination of key columns;
extracting, from a plurality of the detected first code blocks, a plurality of second code blocks between which two-dimensional array data targeted by the first function code is the same, and aggregate computation code included in the first code is the same;
selecting key columns to be used for a link table that is obtained by reducing the number of key columns of the target two-dimensional array data, based on the aggregate computation code included in the second code blocks and key columns of the target two-dimensional array data;
generating third code using the first function code, the selected key columns, and the aggregate computation code, and adding the generated third code at a beginning of the second code blocks; and
converting the plurality of second code blocks into fourth code by aligning the second code blocks with the third code, based on the third code.

Furthermore, in order to achieve the example object described above, a computer-readable recording medium according to an example aspect of the present disclosure includes a program recorded on the computer-readable recording medium, the program including instructions that cause the computer to carry out:
detecting, from input code that was stored in a storage device in advance and has been input to be executed by a computer, first code that includes first function code for combining a plurality of key columns included in two-dimensional array data, and executing grouping computation for each combination of key columns;
extracting, from a plurality of the detected first code blocks, a plurality of second code blocks between which two-dimensional array data targeted by the first function code is the same, and aggregate computation code included in the first code is the same;
selecting key columns to be used for a link table that is obtained by reducing the number of key columns of the target two-dimensional array data, based on the aggregate computation code included in the second code blocks and key columns of the target two-dimensional array data;
generating third code using the first function code, the selected key columns, and the aggregate computation code, and adding the generated third code at a beginning of the second code blocks; and
converting the plurality of second code blocks into fourth code by aligning the second code blocks with the third code, based on the third code.

### Advantageous Effects of the Invention

As described above, according to the present disclosure, it is possible to increase the speed (shorten the computation time) of grouping computation that uses a plurality of key columns of a table (two-dimensional array data) included in input code.

### BRIEF DESCRIPTION OF THE DRAWINGS

FIG. 1 is a diagram for describing Target Encoding.

FIG. 2 is a diagram for describing Target Encoding in a case where an encoding target is extended to a plurality of categorical variables.

FIG. 3 is a diagram for describing code of Target Encoding.

FIG. 4 is a diagram showing an example of a system that includes the code conversion apparatus.

FIG. 5 is a diagram for describing the second code blocks according to the first example embodiment.

FIG. 6 is a diagram for describing the third code according to the first example embodiment.

FIG. 7 is a diagram for describing alignment of code according to the first example embodiment.

FIG. 8 is a diagram for describing an example of operations of the code conversion apparatus according to the first example embodiment.

FIG. 9 is a diagram for describing an example of the code conversion apparatus according to the second example embodiment.

FIG. 10 is a diagram for describing second code blocks according to the second example embodiment.

FIG. 11 is a diagram for describing third code according to the second example embodiment.

FIG. 12 is a diagram for describing alignment of code according to the second example embodiment.

FIG. 13 is a diagram for describing an example of operations of the selection unit of the code conversion apparatus according to the second example embodiment.

FIG. 14 is a diagram illustrating an example of a computer that realizes the code conversion apparatus in the first and second example embodiments.

### EXAMPLE EMBODIMENTS

First, an overview is given for ease of understanding example embodiments to be described below.

Pre-processing for generating training data that is used for machine learning includes feature amount generation processing. As feature amount generation processing, for example, Target Encoding (or Target Mean Encoding (Likelihood Encoding)) for converting categorical variables into numerical values (feature amounts) is known. Target Encoding is processing for aggregating target variables for each categorical variable, and converting the aggregated value into a numerical value (the maximum value, the minimum value, the total sum, the number of values, the mean value, or the like).

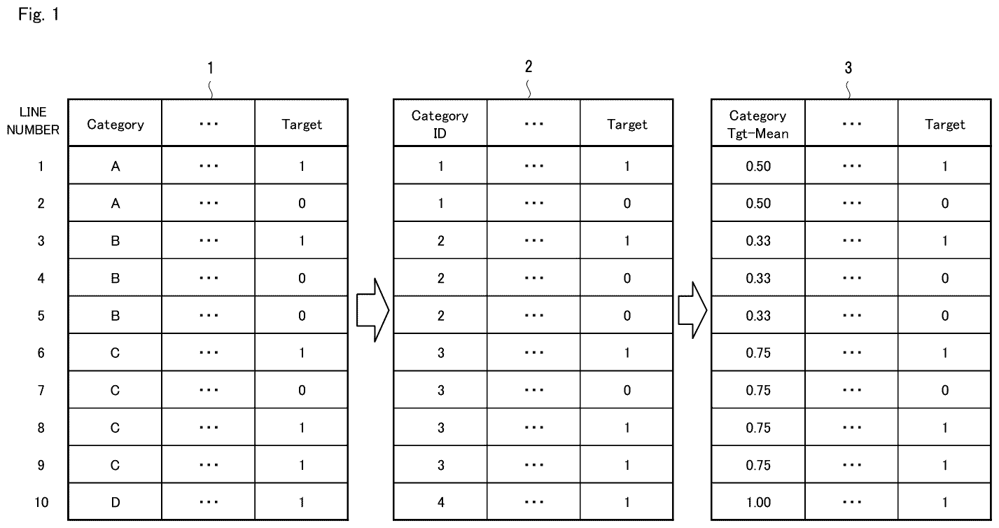

FIG. 1 is a diagram for describing Target Encoding. When the table 1 shown in FIG. 1 is used as input for machine learning, data in the “Category” column of the table 1, which is not composed of numerical values, cannot be used as input for machine learning as is.

In view of this, data in a “Category” column in a table 1 shown in FIG. 1 is converted, using Target Encoding, into numerical values such as data shown in a “Category Tgt-Mean” column of a table 3, the data being obtained by aggregating target variables.

In that case, first, the data in the “Category” column of the table 1, namely categorical variables A, B, C, and D are respectively set to information (numerical values that are meaningless themselves), such as integer values, for example, data shown in a “Category ID” column of a table 2. In the example in FIG. 1, 1 is set as the categorical variable A, 2 is set as the categorical variable B, 3 is set as the categorical variable C, and 4 is set as the categorical variable D.

Next, a mean value is calculated for each categorical variable as with data shown in the “Category Tgt-Mean” column of the table 3 using the data shown in the “Category ID” column of the table 2. In the example in FIG. 1, the categorical variable A is converted into a numerical value of 0.50 (=(1+0)/2), the categorical variable B is converted into a numerical value of 0.33 (=(1+0+0)/3), the categorical variable C is converted into a numerical value of 0.75 (=(1+0+1+1)/4), and the categorical variable D is converted into a numerical value of 1.00 (=(1)/1).

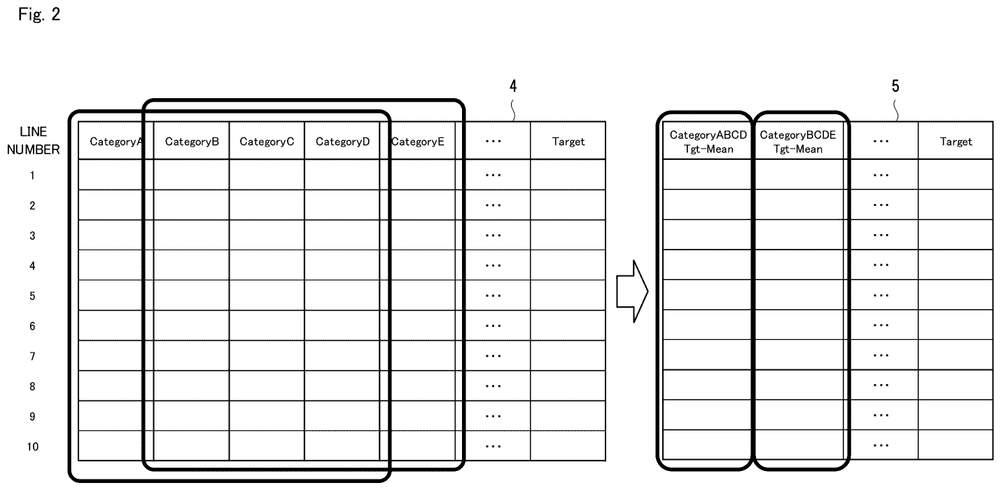

Next, an example where Target Encoding is performed on a combination of categorical variables, not a single categorical variable only, will be described with reference to FIG. 2. FIG. 2 is a diagram for describing Target Encoding in a case where an encoding target is extended to a plurality of categorical variables.

In the example in FIG. 2, Target Encoding is performed using four categorical variables from among categorical variables “Category A”, “Category B”, “Category C”, “Category D”, and the “Category E” in the table 4. Note that, in the example in FIG. 2, data in the columns is omitted for convenience.

In the example in FIG. 2, Target Encoding that uses the categorical variables “Category A”, “Category B”, “Category C”, and “Category D” and Target Encoding that uses the categorical variables “Category B”, “Category C”, “Category D”, and “Category E” are executed.

As a result, categorical variables “Category ABCD Tgt-Mean” and “Category BCDE Tgt-Mean” in the table 5 shown in FIG. 2 are generated.

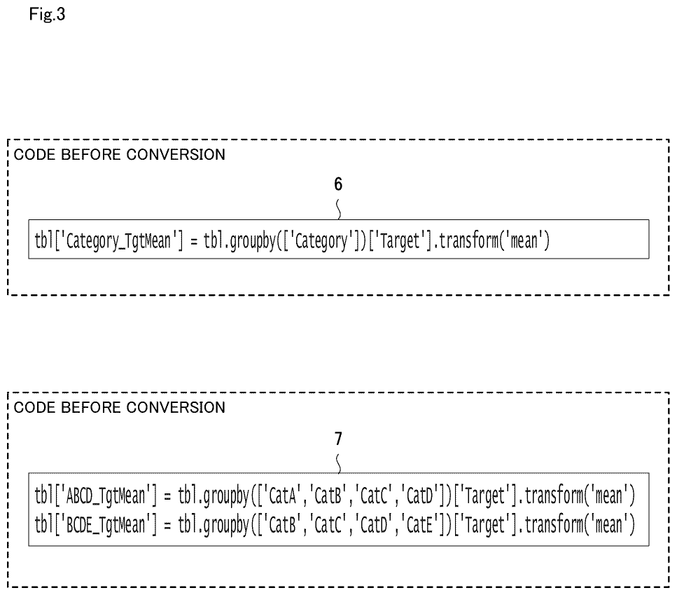

Target Encoding that uses a table processing library will be described. FIG. 3 is a diagram for describing code of Target Encoding. The code shown in FIG. 3 is an example of code in which “groupby” and “transform” of pandas that is a Python table processing library are used.

The code 6 in FIG. 3 is code of Target Encoding that uses a single categorical variable, which has been described with reference to FIG. 1. The code 7 in FIG. 3 is code of Target Encoding that uses a plurality of categorical variables, which has been described with reference to FIG. 2.

“groupby” used in the code 6 and 7 is a function (or method) for performing grouping (classification into groups). “transform” is a function (or method) for rewriting data using obtained statistical information (the maximum value, the minimum value, the total sum, the number of values, the mean value, etc.).

“Category”, “CatA”, “CatB”, “CatC”, “CatD”, and “CatE” written in the code 6 and 7 respectively represent the columns “Category”, “Category A”, “Category B”, “Category C”, “Category D”, and “Category E” shown in FIGS. 1 and 2. “Target” represents “Target” shown in FIGS. 1 and 2. “Category_TgtMean”, “ABCD_TgtMean”, and “BCDE_TgtMean” respectively represent “Category Tgt-Mean”, “Category ABCD Tgt-Mean”, and “Category BCDE Tgt-Mean” shown in FIGS. 1 and 2.

Processing that is executed by the code 6 and 7 includes processing for generating groups and processing for calculating an aggregated value for each group. In the case of the code 6, the following groups GRP0, GRP1, GRP2, and GRP3 are generated for the respective categorical variables by performing processing for generating groups.

Note that numerical values that represent elements included in the following groups GRP0 to GRP3 are expressed by using the row numbers shown in FIG. 1.

| | |
|---|---|
| GRP0: 0, 1 | (group of Category A) |
| GRP1: 2, 3, 4 | (group of Category B) |
| GRP2: 5, 6, 7, 8 | (group of Category C) |
| GRP3: 9 | (group of Category D) |

Furthermore, in the case of the code 6, by calculating aggregated values for the respective groups, the following mean values are calculated for the respective groups.

| | |
|---|---|
| GRP0: the mean value (0.50) of 0 and 1 | (A in Category Tgt-Mean) |
| GRP1: the mean value (0.33) of 2, 3, and 4 | (B in Category Tgt-Mean) |
| GRP2: the mean value (0.75) of 5, 6, 7, | (C in Category Tgt-Mean) |
| and 8 | |
| GRP3: the mean value (1.00) of 9 | (D in Category Tgt-Mean) |

However, in a case where “groupby” is executed using a plurality of columns (key columns) a plurality of times while changing a combination of key columns, and there is a redundant key column, redundant processing (similar and unnecessary processing) will be executed.

Specifically, when “groupby” is executed twice on two combinations such as those shown in the code 7, namely a combination of the categorical variables “Category A”, “Category B”, “Category C”, and “Category D” and a combination of the categorical variables “Category B”, “Category C”, “Category D”, and “Category E”, redundant processing (similar and unnecessary processing) will be executed since the categorical variables “Category B”, “Category C”, and “Category D” are redundant.

Therefore, the computation speed of feature amount generation processing decreases (computation time increases) by a time of execution of unnecessary processing. Furthermore, the more the number of key columns increases, the more the computation amount increases.

Through the afore-mentioned processing, the inventor found an issue of increasing the computation speed (shortening the computation time) for feature amount generation processing, and also came to derive a means for solving this issue.

That is to say, the inventor came to derive a means for converting code that is used for executing grouping computation that uses a plurality of key columns included in two-dimensional array data (a table), into code that makes it possible to increase the computation speed (shorten the computation time). As a result, it is possible to increase the computation speed (shorten the computation time) for feature amount generation processing.

Hereinafter, example embodiments will be described with reference to the drawings. Note that, in the drawings described below, elements having the same functions or corresponding functions are denoted by the same reference numerals, and repeated description thereof may be omitted.

### FIRST EXAMPLE EMBODIMENT

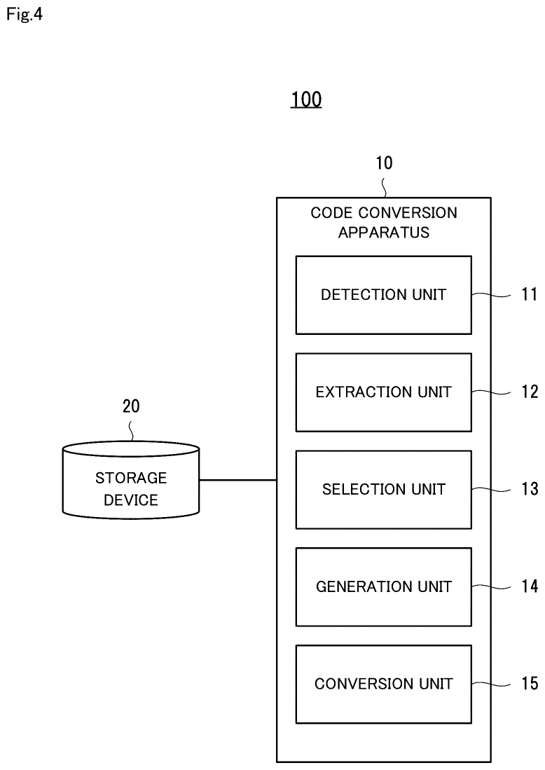

A configuration of a code conversion apparatus 10 according to a first example embodiment will be described in more detail with reference to FIG. 4. FIG. 4 is a diagram showing an example of a system that includes the code conversion apparatus.

### [System Configuration]

In the example in FIG. 4, a system 100 includes the code conversion apparatus 10 and a storage device 20.

The code conversion apparatus 10 is an information processing apparatus such as a CPU (Central Processing Unit), a programmable device such as an FPGA (Field-Programmable Gate Array), a GPU (Graphics Processing Unit), a circuit in which one or more thereof are mounted, a server computer, a personal computer, or a mobile terminal.

The code conversion apparatus 10 is an apparatus that is used for increasing the speed (shortening the computation time) of grouping computation that uses a plurality of key columns of input code, the key columns being included in a table (two-dimensional array data). That is to say, the code conversion apparatus 10 converts code that is included in input code and is used for grouping computation, into code for reducing the initial number of rows in the table that are used for the grouping computation, and performing aggregate computation on a table obtained by reducing the number of rows (link table), thereby reducing the number of times of the computation.

The storage device 20 stores computer-executable input code (code before conversion) that is used for generating training data. In addition, the storage device 20 stores code that can increase the computation speed (shorten the computation time) (code after conversion).

The code conversion apparatus according to the first example embodiment will be described in detail.

As shown in FIG. 4, the code conversion apparatus 10 according to the first example embodiment includes a detection unit 11, an extraction unit 12, a selection unit 13, a generation unit 14, and a conversion unit 15.

Note that specific processing of code conversion that is performed using code in which “groupby” of pandas that is a python table processing library is used will be described. Note that the language for writing code is not limited to python.

The detection unit 11 detects, from input code that was stored in the storage device 20 in advance and has been input to be executed by a computer, first code that includes first function code for combining a plurality of key columns included in a table (two-dimensional array data), and executing grouping computation for each combination of key columns.

The input code is code created by the user using Python or the like. Specifically, the input code is code that includes a groupby method (function belonging to an object) for executing aggregate computation on the same table that includes a plurality of key columns a plurality of times while changing a combination of key columns.

Data in the table (two-dimensional array data) is data having a Python two-dimensional structure (DataFrame), for example. The first function code is a groupby method of pandas that is a Python table processing library, for example. The first code is code that includes the groupby method, for example.

The extraction unit 12 extracts, from the plurality of detected first code blocks, a plurality of second code blocks between which a table (two-dimensional array data) targeted by the first function code is the same, and aggregate computation code included in the first code is the same.

The aggregate computation code is code that is used for performing aggregate computation such as an aggregate method, a transform method, or the like of Python. The aggregate method and the transform method are methods for collectively executing a plurality of aggregate computations.

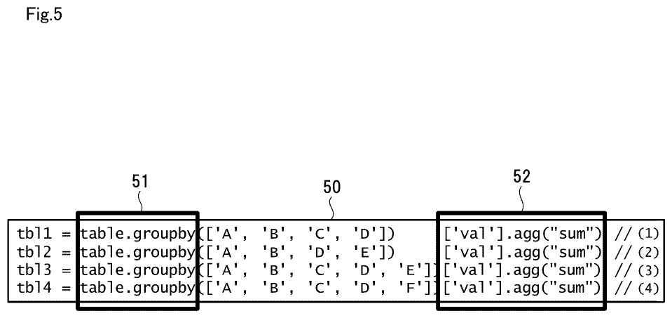

FIG. 5 is a diagram for describing the second code blocks according to the first example embodiment. In the example in FIG. 5, four second code blocks 50 ((1), (2), (3), and (4)) extracted by the extraction unit 12 from the plurality of first code blocks detected by the detection unit 11 are illustrated. In addition, in 51 in FIG. 5, first function code (groupby ( ) and the same table targeted by the first function code are shown.

52 in FIG. 5 includes aggregate computation code ([‘val’].agg (“sum”)) included in the second code blocks. “sum” in the aggregate computation code represents the sum function. The sum function is a function that computes the total sum. Note that, in addition to the sum function, a max function (function that computes the maximum value), a min function (function that computes the minimum value), a count function (function that computes the number of values), a mean function (function that computes the mean value), and the like may be used. [‘val’] in the aggregate computation code is aggregate computation column data targeted by the aggregate computation code.

The selection unit 13 selects key columns to be used for a link table that is obtained by reducing the number of key columns of the target two-dimensional array data, based on the aggregate computation code included in the second code blocks and key columns of the target two-dimensional array data.

Specifically, first, in a case where the aggregate computation code included in the second code blocks includes a function that computes the maximum value, the minimum value, the total sum, or the number of values (the sum function, the max function, the min function, or the count function), the selection unit 13 combines sets of key columns of the second code blocks, and determines whether or not, in each combination, a set of key columns of a target second code block included in the combination includes a set of key columns of another second code block.

Next, if it is determined that there is a combination in which a set of key columns of a target second code block includes a set of key columns of another second code block, the selection unit 13 selects the key columns of the second code blocks included in the combination.

In the example in FIG. 5, a plurality of second code blocks include aggregate computation code “[‘val’].agg (“sum”)”.

In addition, in the example in FIG. 5, the set of key columns of the second code block denoted by (1) is [‘A’, ‘B’, ‘C’, ‘D’]. The set of key columns of the second code block denoted by (2) is [‘A’, ‘B’, ‘D’, ‘E’]. The set of key columns of the second code block denoted by (3) is [‘A’, ‘B’, ‘C’, ‘D’, ‘E’]. The set of key columns of the second code block denoted by (4) is [‘A’, ‘B’, ‘C’, ‘D’, ‘F’].

Next, in none of the combinations of (1), (2), (3), and (4), the set of key columns of a target second code block includes the set of key columns of another second code block.

Next, from among the combination of (1), (2), and (3), the combination of (1), (2), and (4), the combination of (1), (3), and (4), and the combination of (2), (3), and (4), in the combination of (1), (2), and (3), the set of key columns in (3) includes the set of key columns in (1) and (2), and thus, in the example in FIG. 5, the key columns in (1), (2), and (3) are selected. In that case, the set of key columns in (4) is excluded.

Note that the combination of (1), (2), and (4), the combination of (1), (3), and (4), and the combination of (2), (3), and (4) do not include a combination in which a set of key columns of a target second code block includes a set of key columns of another second code block, and thus these combinations are not selected.

The generation unit 14 generates third code using the first function code, the selected key columns to be used for a link table, and the aggregate computation code, and adds the third code at the beginning of the second code blocks.

Specifically, first, the generation unit 14 generates third code using the key columns of target second code blocks that are included in the selected combination. Next, the generation unit 14 adds the generated third code at the beginning of the second code blocks.

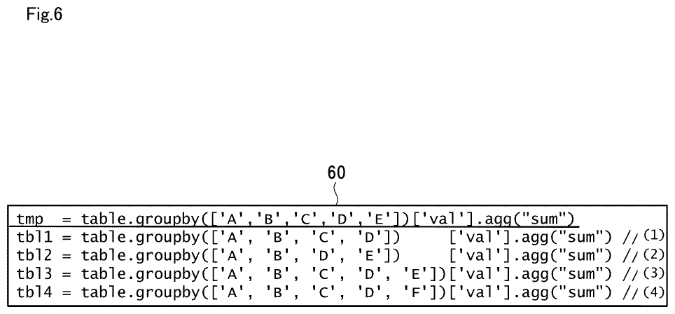

FIG. 6 is a diagram for describing the third code according to the first example embodiment. In the example in FIG. 6, the combination of (1), (2), and (3) is selected, and thus third code “tmp=table.groupby ([‘A’, ‘B’, ‘C’, ‘D’, ‘E’]) [‘val’].agg (“sum”)” (the underlined section) is generated using the first function code “table.groupby”, the set of key columns [‘A’, ‘B’, ‘C’, ‘D’, ‘E’] (link table) of the second code block denoted by (3), and the aggregate computation code “[‘val’].agg (“sum”)”.

The conversion unit 15 converts the plurality of second code blocks into fourth code by aligning the second code blocks with the third code, based on the third code. Specifically, the conversion unit 15 converts a table of the second code blocks included in the selected combination into fourth code that uses the link table of the third code, based on the third code.

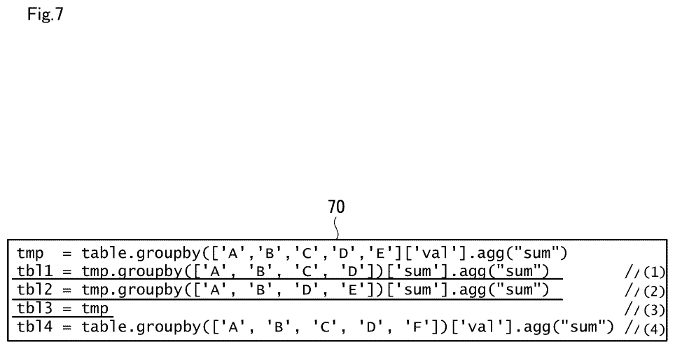

FIG. 7 is a diagram for describing alignment of code according to the first example embodiment. In the example in FIG. 7, the combination of (1), (2), and (3) is selected, and thus the second code blocks of (1), (2), and (3) are respectively converted into fourth code blocks expressed as (1) “tbl1=tmp.groupby ([‘A’, ‘B’, ‘C’, ‘D’]) [‘sum’].agg (“sum”)” (the underlined section), (2) “tbl2=tmp.groupby ([‘A’, ‘B’, ‘D’, ‘E’]) [‘sum’].agg (“sum”)” (the underlined section), and (3) “tbl3=tmp” (the underlined section) in FIG. 7, based on the third code “tmp=table.groupby ([‘A’, ‘B’, ‘C’, ‘D’, ‘E’]) [‘val’].agg (“sum”)”.

That is to say, the second code blocks are converted into code blocks for executing aggregate computation, using, not the initial table having a large size, but a link table tmp having a smaller size than the initial table.

In this manner, the third code (tmp=table.groupby ([‘A’, ‘B’, ‘C’, ‘D’, ‘E’]) [‘val’].agg (“sum”)) for performing groupby total sum computation on the table once is generated, and the second code blocks are converted into fourth code blocks (tbl1=tmp.groupby ([‘A’, ‘B’, ‘C’, ‘D’]) [‘sum’].agg (“sum”), tbl2=tmp.groupby ([‘A’, ‘B’, ‘D’, ‘E’]) [‘sum’].agg (“sum”), and tbl3=tmp) for performing the groupby total sum computation on the link table tmp three times.

In the first example embodiment, if it is determined that there is a combination in which a set of key columns of a target second code block includes a set of key columns of another second code block, third code is generated using the set of key columns of the target second code blocks included in the selected combination, and the second code blocks are changed into fourth code for aligning the plurality of second code blocks with the third code, based on the generated third code.

Therefore, in the first example embodiment, it is possible to increase the speed (shorten the computation time) of grouping computation that uses a plurality of key columns included in a table (two-dimensional array data). In addition, in the first example embodiment, it is possible to reduce the memory usage during computation.

### [Apparatus Operations]

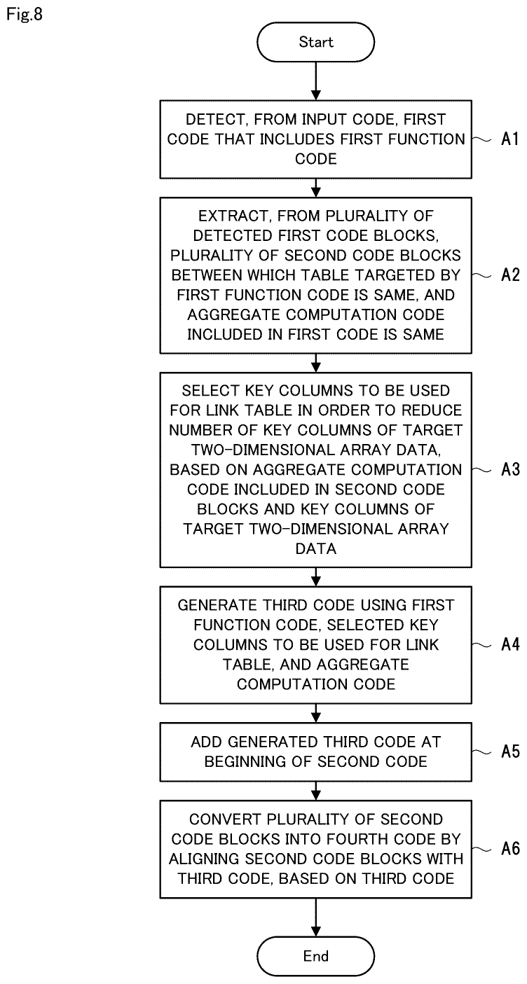

Next, operations of the code conversion apparatus according to the first example embodiment will be described with reference to FIG. 8. FIG. 8 is a diagram for describing an example of operations of the code conversion apparatus according to the first example embodiment. In the following description, drawings are referenced as appropriate. In addition, in the first example embodiment, a code conversion method is performed by causing the code conversion apparatus to operate. Thus, the following description of operations of the code conversion apparatus is used as description of the code conversion method according to the first example embodiment.

As shown in FIG. 8, first, the detection unit 11 detects, from input code that was stored in the storage device 20 in advance and has been input to be executed by a computer, first code that includes first function code for combining a plurality of key columns included in a table (two-dimensional array data), and executing grouping computation for each combination of key columns (step A1).

Next, the extraction unit 12 extracts, from the plurality of detected first code blocks, a plurality of second code blocks between which a table (two-dimensional array data) targeted by the first function code is the same, and aggregate computation code included in the first code is the same (step A2).

Next, the selection unit 13 selects key columns to be used for a link table in order to reduce the number of key columns of the target two-dimensional array data, based on the aggregate computation code included in the second code blocks and key columns of the target two-dimensional array data (step A3).

Next, the generation unit 14 generates third code using the first function code, the selected key columns to be used for a link table, and the aggregate computation code (step A4), and adds the generated third code at the beginning of the second code (step A5).

Next, the conversion unit 15 converts the plurality of second code blocks into fourth code by aligning the second code blocks with the third code, based on the third code (step A6).

Note that, even in a case where input code includes second code that uses a plurality of different tables, it is possible to convert the input code into code for executing grouping computation at a high speed, by repeating the above processing of steps A1 to A6 on the input code.

### Effects of First Example Embodiment

As described above, according to the first example embodiment, if it is determined that there is a combination in which a set of key columns of a target second code block includes a set of key columns of another second code block, third code is generated using the set of key columns of the target second code blocks included in the selected combination (link table), and the plurality of second code blocks are aligned with the third code, and are converted into fourth code, based on the generated third code.

Therefore, in the first example embodiment, it is possible to increase the speed (shorten the computation time) of grouping computation that uses a plurality of key columns included in a table (two-dimensional array data). Also, in the first example embodiment, it is possible to reduce the memory usage during computation.

A detailed description will be given. In a case of, for example, input code for obtaining the maximum value of purchase amount for each of the combinations (age and prefecture of residence), (age and blood type), and (prefecture of residence and blood type), using, as a target, a table (one million records) that includes information regarding age ranges (six types), prefectures of residence (47 types), and blood types (four types), summarization is performed three times using the data of the one million records, and thus redundant processing (similar unnecessary processing) is executed.

However, according to the first example embodiment, first, third code for calculating the maximum value of purchase amount (for summarizing the data of the one million records once) for the combination (of age, prefecture of residence, and blood type) is generated using the table (one million records). That is to say, a link table (maximum 6×47×4=1128 records) is generated based on the third code.

Next, fourth code for calculating the maximum value for each of the combinations (age and prefecture of residence), (age and blood type), and (prefecture of residence and blood type) (for summarizing the data of the 1128 records three times) using the data in the link table (maximum 1128 records) is generated.

By converting, in this manner, the input code for performing summarization using the data of the one million records three times into code for summarizing the data of the one million records once and summarizing the data of the 1128 records three times, it is possible to increase the speed (shorten the computation time) of grouping computation that uses a plurality of key columns included in the initial table (two-dimensional array data). Also, it is possible to reduce the memory usage during computation.

### [Program]

The program according to the first example embodiment may be a program that causes a computer to execute steps A1 to A6 shown in FIG. 8. By installing this program in a computer and executing the program, the code conversion apparatus and a code conversion method according to the first example embodiment can be realized. In this case, the processor of the computer performs processing to function as the detection unit 11, the extraction unit 12, the selection unit 13, the generation unit 14, and the conversion unit 15.

Also, the program according to the first example embodiment may be executed by a computer system constructed by a plurality of computers. In this case, for example, each computer may function as any of the detection unit 11, the extraction unit 12, the selection unit 13, the generation unit 14, and the conversion unit 15.

### SECOND EXAMPLE EMBODIMENT

In a second example embodiment, in a case where aggregate computation code includes computation of the maximum value, the minimum value, the total sum, the number of records, or the mean value, determination is performed on whether or not the speed can be increased, and, if it is determined that the speed can be increased, input code is converted.

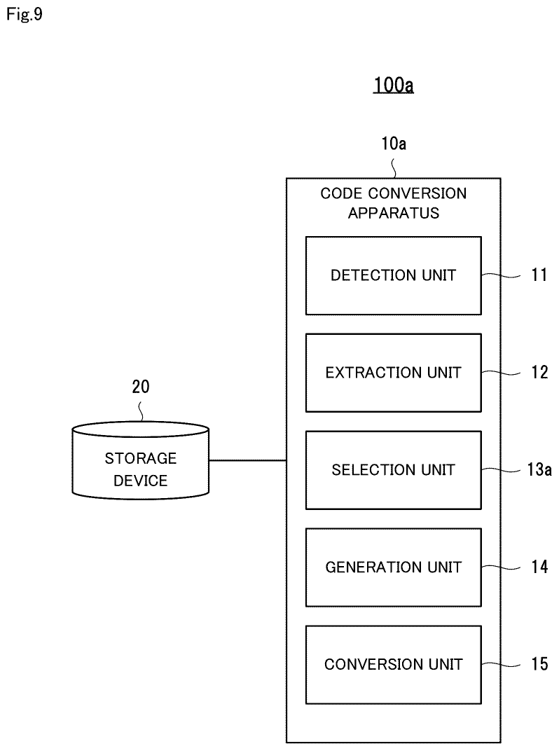

A configuration of a code conversion apparatus according to the second example embodiment will be described with reference to FIG. 9. FIG. 9 is a diagram for describing an example of the code conversion apparatus according to the second example embodiment.

As shown in FIG. 9, a code conversion apparatus 10a according to the second example embodiment includes the detection unit 11, the extraction unit 12, a selection unit 13a, the generation unit 14, and the conversion unit 15.

Note that the detection unit 11, the extraction unit 12, the generation unit 14, and the conversion unit 15 have already been described, and thus a detailed description of the detection unit 11, the extraction unit 12, the generation unit 14, and the conversion unit 15 is omitted.

In a case where computation of aggregate computation code included in second code is computation of the maximum value, the minimum value, the total sum, the number of records, or the mean value, the selection unit 13a determines whether or not the speed of processing that uses third code after conversion is increased compared to processing before conversion, based on the sum of the numbers of key columns included in the second code blocks and the size of the union of sets of key columns of the second code blocks.

Specifically, first, the selection unit 13a determines whether or not the aggregate computation code included in the second code blocks includes a function that computes the maximum value, the minimum value, the total sum, the number of values, or the mean value (the sum function, the max function, the min function, the count function, or the mean function).

Next, if the aggregate computation code included in the second code blocks includes a function that computes the maximum value, the minimum value, the total sum, the number of values, or the mean value, the selection unit 13a calculates the sum P of the numbers of key columns included in the second code blocks and the size Q of the union of sets of key columns of the second code blocks.

In the example in FIG. 5, the number of key columns of each of the second code blocks (1) to (4) that include the sum function is calculated. The number of key columns [‘A’, ‘B’, ‘C’, ‘D’] of (1) is four, the number of key columns [‘A’, ‘B’, ‘D’, ‘E’] of (2) is four, the number of key columns [‘A’, ‘B’, ‘C’, ‘D’, ‘E’] of (3) is five, and the number of key columns [‘A’, ‘B’, ‘C’, ‘D’, ‘F’] of (4) is five. Next, the sum P of the numbers of columns of (1) to (4) is calculated, which is 14 (=4+4+5+5).

In addition, in the example in FIG. 5, the union of sets of key columns of the second code blocks (1) to (4) that include the sum function is [‘A’, ‘B’, ‘C’, ‘D’, ‘E’, ‘F’], and thus the size Q is determined as 6.

Next, the selection unit 13a calculates cost X before processing flow conversion and cost Y after processing flow conversion, based on the sum P of the numbers of columns and the size Q of the union of sets.

The cost X before processing flow conversion can be expressed using the sum P of the numbers of columns, for example. Specifically, the cost X before processing flow conversion can be expressed using the area of the table used for each groupby computation. Here, the area of the table used for each groupby computation is expressed as the sum P of the numbers of key columns used for each groupby computation×the number of rows L of the original table.

In the example in FIG. 5, when the number of rows of the original table is denoted by L, the area for (1) is expressed as 4 L, the area for (2) is expressed as 4 L, the area for (3) is expressed as 5 L, and the area for (4) is expressed as 5 L. Therefore, in the example in FIG. 5, the cost X before processing flow conversion is expressed as 4 L+4 L+5 L+5 L=14 L.

In a case where the aggregate computation code includes a function that computes the maximum value, the minimum value, the total sum, or the number of values, the cost Y after processing flow conversion can be expressed as (the size Q of the union of sets×the number of rows L of the original table)+((a coefficient α×the number of rows L of the original table)× the sum P of the numbers of key columns used for each groupby computation), for example.

Specifically, the cost Y after processing flow conversion can be expressed as the sum of the cost of generating a link table and the cost of performing groupby calculation based on the link table. The cost of performing groupby calculation based on the link table can be expressed as P×(Δ×L) based on the assumption that the number of rows L for groupby decreases by a factor of a (0≤α<1). Therefore, the cost Y after processing flow conversion can be expressed as (Q×L)+P×(Δ×L).

Note that the coefficient α is a value expressed as 0≤α<1, and is set to any suitable value in advance. Note that the setting is performed on the assumption that, the larger the coefficient α is, the more likely the link table remains large and the size thereof does not decrease.

In the example in FIG. 5, in a case where the coefficient α is set to 0.2, the size Q of the union of sets is 6, the number of rows of the original table is denoted by L, and the sum P of the numbers of key columns used for respective groupby computations is 14, the cost Y after processing flow conversion in (1) to (4) is expressed as Y=6 L+0.2 L×14 (=L×(6+0.2×14)=8.8 L).

Note that, both the cost X before processing flow conversion and the cost Y after processing flow conversion include the number of rows L of the original table, but the number of rows is the same, and thus the cost X of 14 may be simply compared with the cost of 8.8.

Note that the cost Y after processing flow conversion in a case where the aggregate computation code includes a function that computes the mean value can be expressed as ((Q×L)+ ((α×L)×P))×2. The reason for doubling is that, in the case of calculating the mean value, computation is performed using the total sum and the number of values.

Next, the selection unit 13a compares the cost X before processing flow conversion with the cost Y after processing flow conversion, and determines whether or not an effect of increasing the speed is achieved. That is to say, the selection unit 13a determines that an effect of increasing the speed is achieved if the cost Y after processing flow conversion is smaller than the cost X before processing flow conversion (X>Y).

In the example in FIG. 5, since the cost X before processing flow conversion is 14 and the cost Y after processing flow conversion is 8.8, it can be determined that an effect of increasing the speed is achieved.

Next, the selection unit 13a selects key columns of target second code blocks included in a combination for which it is determined that an effect of increasing the speed is achieved.

Next, the generation unit 14 generates third code using the key columns of the target second code blocks included in the combination for which it is determined that an effect of increasing the speed is achieved. Next, the generation unit 14 adds the generated third code at the beginning of the second code blocks.

Next, the conversion unit 15 converts the second code blocks included in the selected combination into fourth code, by aligning the second code blocks with the third code, based on the third code.

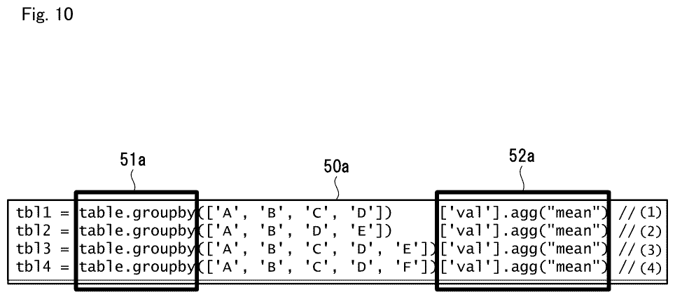

FIG. 10 is a diagram for describing second code blocks according to the second example embodiment. In the example in FIG. 10, a plurality of second code blocks 50a ((1), (2), (3), and (4)) extracted by the extraction unit 12 from a plurality of first code blocks detected by the detection unit 11 are shown. In addition, in 51a in FIG. 10, first function code (groupby ( ) and the same table targeted by the first function code are shown.

52a in FIG. 10 includes aggregate computation code ([‘val’].agg (“mean”)) included in the second code blocks. “mean” in the aggregate computation code represents the mean function.

In the example in FIG. 10, the set of key columns of the second code block denoted by (1) is [‘A’, ‘B’, ‘C’, ‘D’]. The set of key columns of the second code block denoted by (2) is [‘A’, ‘B’, ‘D’, ‘E’]. The set of key columns of the second code block denoted by (3) is [‘A’, ‘B’, ‘C’, ‘D’, ‘E’]. The set of key columns of the second code block denoted by (4) is [‘A’, ‘B’, ‘C’, ‘D’, ‘F’].

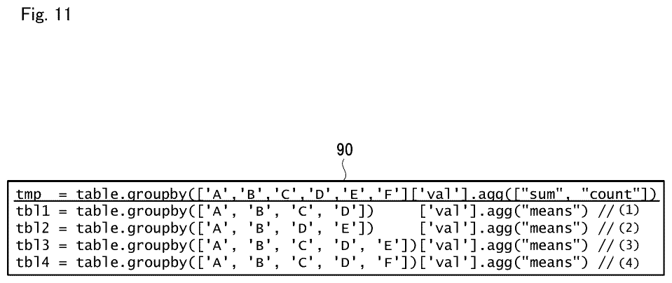

FIG. 11 is a diagram for describing third code according to the second example embodiment. In the example in FIG. 11, the selection unit 13a determines that an effect of increasing the speed is achieved if the cost Y after processing flow conversion is smaller than the cost X before processing flow conversion (X>Y), in combinations of (1), (2), (3), and (4), and thus generates third code (“tmp=table.groupby ([‘A’, ‘B’, ‘C’, ‘D’, ‘E’, ‘F’]) [‘val’].agg ([” sum “, “count”])” (the underlined section)), using the first function code “table.groupby”, the set of key columns [‘A’, ‘B’, ‘C’, ‘D’, ‘E’, ‘F’] of the second code block denoted by (3), and the aggregate computation code “[‘val’].agg (“sum”)”.

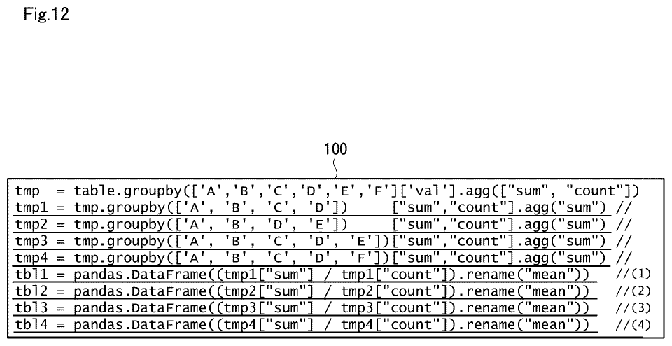

FIG. 12 is a diagram for describing alignment of code according to the second example embodiment. Next, in the example in FIG. 12, the combination of (1), (2), (3), and (4) is selected, and thus the second code blocks (1), (2), (3), and (4) are converted into fourth code, based on the third code “tmp=table.groupby ([‘A’, ‘B’, ‘C’, ‘D’, ‘E’, ‘F’]) [‘val’].agg ([“sum”, “count”])”.

That is to say, the second code blocks are converted into fourth code blocks described as “tmp1=tmp.groupby ([‘A’, ‘B’, ‘C’, ‘D’]) [” sum “, “count”].agg (“sum”)” (the underlined section), “tmp2=tmp.groupby ([‘A’, ‘B’, ‘D’, ‘E’]) [” sum “, “count”].agg (“sum”)” (the underlined section), “tmp3=tmp.groupby ([‘A’, ‘B’, ‘C’, ‘D’, ‘E’]) [” sum “, “count”].agg (“sum”)” (the underlined section), “tmp4=tmp.groupby ([‘A’, ‘B’, ‘C’, ‘D’, ‘F’]) [” sum “, “count”].agg (“sum”)” (the underlined section), (1) “tbl1=pandas. DataFrame ((tmp1[” sum “]/tmp1 [” count “]).rename (“mean”))” (the underlined section), (2) “tbl2=pandas.DataFrame ((tmp2[” sum “]/tmp2[” count “]).rename (“mean”))” (the underlined section), (3) “tbl3=pandas.DataFrame ((tmp3[” sum “]/tmp3[” count “]).rename (“mean”))” (the underlined section), and (4) “tbl4=pandas.DataFrame ((tmp4[” sum “]/tmp4[” count “]).rename (“mean”))” (the underlined section) in FIG. 12.

In this manner, the third code (tmp=table.groupby ([‘A’, ‘B’, ‘C’, ‘D’, ‘E’, ‘F’][‘val’].agg ([“sum”, “count”])) for performing groupby total sum computation on the table once is generated, and the second code blocks are converted into fourth code blocks for performing groupby mean value computation on the link table tmp.

In the link table tmp in FIG. 12, a sum column stores the total sum of values of each group obtained by performing groupby computation by A, B, C, D, E, and F and a count row stores the number of values, as results. Furthermore, it is possible to calculate the total sum and the number of values of each group by performing groupby+agg (sum) computation on the link table tmp, and the average can be calculated by calculating the total sum/the number of values.

In the second example embodiment, in a case where the aggregate computation code includes computation of the maximum value, the minimum value, the total sum, the number of records, or the mean value, determination is performed on whether or not the speed can be increased, and if it is determined that the speed can be increased, the input code is converted.

Therefore, in the first example embodiment, it is possible to increase the speed (shorten the computation time) of grouping computation that uses a plurality of key columns included in a table (two-dimensional array data). In addition, in the first example embodiment, it is possible to reduce the memory usage during computation.

### [Apparatus Operations]

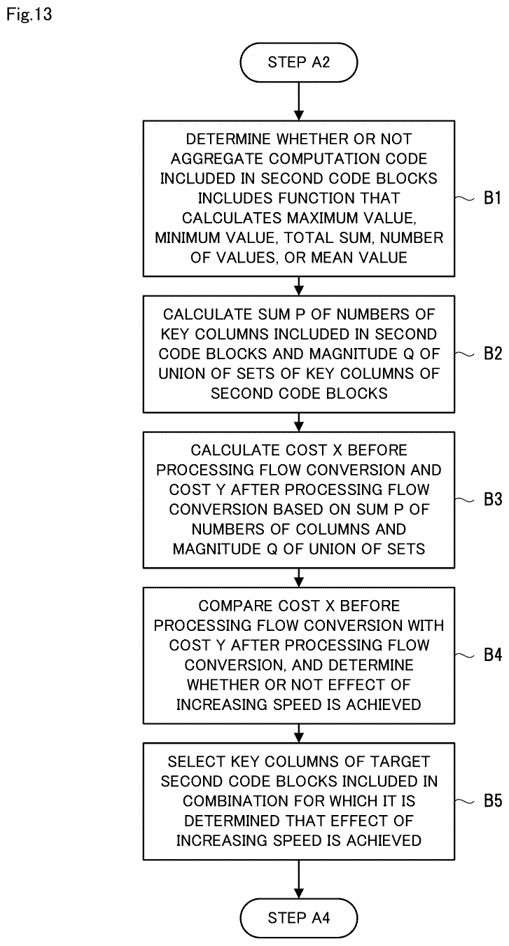

Next, operations of the code conversion apparatus according to the second example embodiment will be described with reference to FIG. 13. FIG. 13 is a diagram for describing an example of operations of the selection unit of the code conversion apparatus according to the second example embodiment. In the following description, drawings are referenced as appropriate. In addition, in the second example embodiment, a code conversion method is performed by causing the code conversion apparatus to operate. Thus, the following description of operations of the code conversion apparatus is used as description of the code conversion method according to the second example embodiment.

In the second example embodiment, the processing of step A3 in the first example embodiment described with reference to FIG. 8 is replaced with later-described processing of steps B1 to B5.

As shown in FIG. 13, first, the selection unit 13a determines whether or not the aggregate computation code included in the second code blocks extracted in the processing of steps A1 and A2 in FIG. 8 includes a function that calculates the maximum value, the minimum value, the total sum, the number of values, or the mean value (the sum function, the max function, the min function, the count function, or the mean function) (step B1).

Next, in a case where the aggregate computation code included in the second code blocks includes a function that calculates the maximum value, the minimum value, the total sum, the number of values, or the mean value, the selection unit 13a calculates the sum P of the numbers of key columns included in the second code blocks and the size Q of the union of sets of key columns of the second code blocks (step B2).

Next, the selection unit 13a calculates cost X before processing flow conversion and cost Y after processing flow conversion based on the sum P of the numbers of columns and the size Q of the union of sets (step B3).

Next, the selection unit 13a compares the cost X before processing flow conversion with the cost Y after processing flow conversion, and determines whether or not an effect of increasing the speed is achieved (step B4). That is to say, in step B4, if the cost Y after processing flow conversion is smaller than the cost X before processing flow conversion (X>Y), the selection unit 13a determines that an effect of increasing the speed is achieved.

Next, the selection unit 13a selects key columns of target second code blocks included in a combination for which it is determined that an effect of increasing the speed is achieved (step B5). The processing of steps A4 to A6 in FIG. 8 is then executed.

### Effects of Second Example Embodiment

As described above, according to the second example embodiment, in a case where aggregate computation code includes computation of the maximum value, the minimum value, the total sum, the number of records, or the mean value, determination is performed on whether or not the speed can be increased, and if it is determined that the speed can be increased, input code is converted.

Therefore, in the second example embodiment, it is possible to increase the speed (shorten the computation time) of grouping computation that uses a plurality of key columns included in a table (two-dimensional array data). In addition, in the first example embodiment, it is possible to reduce the memory usage during computation.

### [Program]

The program according to the second example embodiment may be a program that causes a computer to execute steps A1 to A2 and A4 to A6 shown in FIG. 8 and steps B1 to B5 shown in FIG. 13. By installing this program in a computer and executing the program, the code conversion apparatus and a code conversion method according to the second example embodiment can be realized. In this case, the processor of the computer performs processing to function as the detection unit 11, the extraction unit 12, the selection unit 13a, the generation unit 14, and the conversion unit 15.

Also, the program according to the first example embodiment may be executed by a computer system constructed by a plurality of computers. In this case, for example, each computer may function as any of the detection unit 11, the extraction unit 12, the selection unit 13a, the generation unit 14, and the conversion unit 15.

### [Physical Configuration]

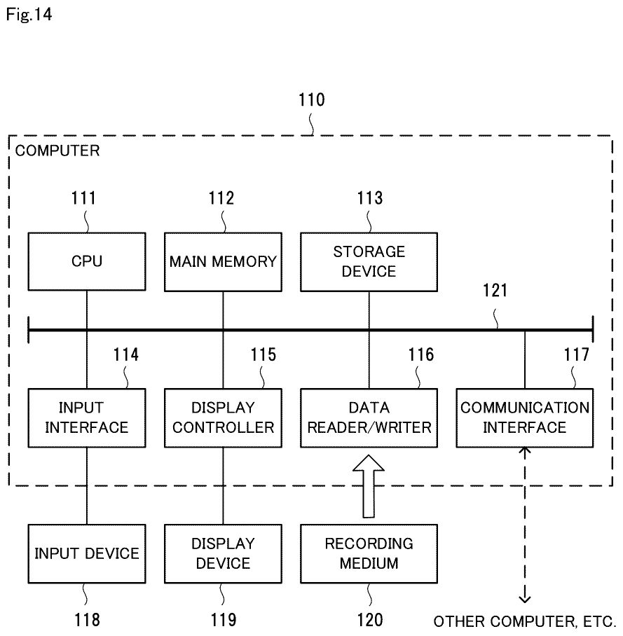

Here, a computer that realizes the code conversion apparatus by executing the program according to the first second example embodiments will be described with reference to FIG. 14. FIG. 14 is a diagram illustrating an example of a computer that realizes the code conversion apparatus in the first and second example embodiments.

As shown in FIG. 14, a computer 110 includes a CPU111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU or a FPGA in addition to the CPU111 or instead of the CPU111.

The CPU111 loads a program (codes) according to the first and second example embodiments and the first and second working examples stored in the storage device 113 to the main memory 112, and executes them in a predetermined order to perform various kinds of calculations. The main memory 112 is typically a volatile storage device such as a DRAM (Dynamic Random Access Memory). Also, the program according to the example embodiments are provided in the state of being stored in a computer-readable recording medium 120. Note that the program according to the first and second example embodiments and the first and second working examples may be distributed on the Internet that is connected via the communication interface 117. a computer-readable recording medium 120 is a non-volatile recording medium.

Specific examples of the storage device 113 include a hard disk drive, and a semiconductor storage device such as a flash memory. The input interface 114 mediates data transmission between the CPU111 and the input device 118 such as a keyboard or a mouse. The display controller 115 is connected to a display device 119, and controls the display of the display device 119.

The data reader/writer 116 mediates data transmission between the CPU111 and the recording medium 120, and reads out the program from the recording medium 120 and writes the results of processing performed in the computer 110 to the recording medium 120. The communication interface 117 mediates data transmission between the CPU111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The code conversion apparatus according to the first and second example embodiments can also be achieved using hardware corresponding to the components, instead of a computer in which a program is installed. Furthermore, a part of the code conversion apparatus may be realized by a program and the remaining part may be realized by hardware.

Although the invention has been described with reference to the embodiments, the invention is not limited to the example embodiment described above. Various changes can be made to the configuration and details of the invention that can be understood by a person skilled in the art within the scope of the invention.

### INDUSTRIAL APPLICABILITY

According to the above description, it is possible to increase the speed (shorten the computation time) of grouping computation that uses a plurality of key columns of a table (two-dimensional array data) included in input code. In addition, the present invention is useful in a field in which grouping computation that uses a plurality of key columns included in two-dimensional array data (table) is required.

### LIST OF REFERENCE SIGNS

10, 10a Code conversion apparatus
11 Detection unit
12 Extraction unit
13, 13a Selection unit
14 Generation unit
15 Conversion unit
20 Storage device
100, 100a System
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. A code conversion apparatus comprising:
at least one memory storing instructions; and
at least one processor configured to execute the instructions to:
detect from input code that was stored in a storage device in advance and has been input to be executed by a computer, first code that includes first function code for combining a plurality of key columns included in two-dimensional array data, and executing grouping computation for each combination of key columns;
extract from a plurality of the detected first code blocks, a plurality of second code blocks between which two-dimensional array data targeted by the first function code is the same, and aggregate computation code included in the first code is the same;
select key columns to be used for a link table that is obtained by reducing the number of key columns of the target two-dimensional array data, based on the aggregate computation code included in the second code blocks and key columns of the target two-dimensional array data;
generate third code using the first function code, the selected key columns, and the aggregate computation code, and adding the generated third code at a beginning of the second code blocks; and
convert the plurality of second code blocks into fourth code by aligning the second code blocks with the third code, based on the third code.

2. The code conversion apparatus according to claim 1,
wherein the one or more processors further:
in a case where the aggregate computation code included in the second code blocks includes a function that computes a maximum value, a minimum value, a total sum, or the number of values, combines sets of the key columns of the second code blocks, and determines whether or not, in each combination, a set of key columns of a target second code block included in the combination includes a set of key columns of another second code block; and
if it is determined that there is a combination in which a set of key columns of a target second code block includes a set of key columns of another second code block, selects a set of key columns of the second code blocks included in the combination.

3. The code conversion apparatus according to claim 1,
wherein the one or more processors further:
in a case where computation of the aggregate computation code included in the second code blocks is computation of a maximum value, a minimum value, a total sum, the number of records, or a mean value, determines whether or not processing that uses the third code after conversion makes it possible to increase a speed compared with processing before conversion, based on a sum of numbers of key columns included in the respective second code blocks and a size of union of sets of key columns of the respective second code blocks.

4. A code conversion method that is performed by a computer, the method comprising:
detecting, from input code that was stored in a storage device in advance and has been input to be executed by a computer, first code that includes first function code for combining a plurality of key columns included in two-dimensional array data, and executing grouping computation for each combination of key columns;
extracting, from a plurality of the detected first code blocks, a plurality of second code blocks between which two-dimensional array data targeted by the first function code is the same, and aggregate computation code included in the first code is the same;
selecting key columns to be used for a link table that is obtained by reducing the number of key columns of the target two-dimensional array data, based on the aggregate computation code included in the second code blocks and key columns of the target two-dimensional array data;
generating third code using the first function code, the selected key columns, and the aggregate computation code, and adding the generated third code at a beginning of the second code blocks; and
converting the plurality of second code blocks into fourth code by aligning the second code blocks with the third code, based on the third code.

5. The code conversion method according to claim 4,
wherein, in a case where the aggregate computation code included in the second code blocks includes a function that computes a maximum value, a minimum value, a total sum, or the number of values, sets of the key columns of the second code blocks are combined, and determination is performed on whether or not, in each combination, a set of key columns of a target second code block included in the combination includes a set of key columns of another second code block; and
if it is determined that there is a combination in which a set of key columns of a target second code block includes a set of key columns of another second code block, a set of key columns of the second code blocks included in the combination is selected.

6. The code conversion method according to claim 4,
wherein, in a case where computation of the aggregate computation code included in the second code blocks is computation of a maximum value, a minimum value, a total sum, the number of records, or a mean value, determination is performed on whether or not processing that uses the third code after conversion makes it possible to increase a speed compared with processing before conversion, based on a sum of numbers of key columns included in the respective second code blocks and a size of union of sets of key columns of the respective second code blocks.

7. A non-transitory computer-readable recording medium on which a program is recorded, the program including instructions that cause a computer to carry out:
detecting, from input code that was stored in a storage device in advance and has been input to be executed by a computer, first code that includes first function code for combining a plurality of key columns included in two-dimensional array data, and executing grouping computation for each combination of key columns;
extracting, from a plurality of the detected first code blocks, a plurality of second code blocks between which two-dimensional array data targeted by the first function code is the same, and aggregate computation code included in the first code is the same;
selecting key columns to be used for a link table that is obtained by reducing the number of key columns of the target two-dimensional array data, based on the aggregate computation code included in the second code blocks and key columns of the target two-dimensional array data;
generating third code using the first function code, the selected key columns, and the aggregate computation code, and adding the generated third code at a beginning of the second code blocks; and
converting the plurality of second code blocks into fourth code by aligning the second code blocks with the third code, based on the third code.

8. The non-transitory computer-readable recording medium according to claim 7,
wherein, in a case where the aggregate computation code included in the second code blocks includes a function that computes a maximum value, a minimum value, a total sum, or the number of values, sets of the key columns of the second code blocks are combined, and determination is performed on whether or not, in each combination, a set of key columns of a target second code block included in the combination includes a set of key columns of another second code block; and
if it is determined that there is a combination in which a set of key columns of a target second code block includes a set of key columns of another second code block, a set of key columns of the second code blocks included in the combination is selected.

9. The non-transitory computer-readable recording medium according to claim 7,
wherein, in a case where computation of the aggregate computation code included in the second code blocks is computation of a maximum value, a minimum value, a total sum, the number of records, or a mean value, determination is performed on whether or not processing that uses the third code after conversion makes it possible to increase a speed compared with processing before conversion, based on a sum of numbers of key columns included in the respective second code blocks and a size of union of sets of key columns of the respective second code blocks.
